(19) United States
(12) Patent Application Publication
(10) Pub. No.: US 2005/0216283 A1
(43) Pub. Date: Sep. 29, 2005

(54) Method for automatically associating an image with related content on an image product

(76) Inventors: John R. Squilla, Rochester, NY (US); Joseph A. Manico, Rochester, NY (US); John R. Fredlund, Rochester, NY (US); Dale F. Mclntyre, Honeoye Falls, NY (US)

Correspondence Address: Pamela R. Crocker;Patent Legal Staff, Eastman Kodak Company, 343 State Street, Rochester, NY, 14650-2201, US

(21) Appl. No.: 10/809,023

(22) Filed: Mar. 25, 2004

(51) Int. Cl. G06F 17/60

(52) U.S. Cl. 705/1; 705/14

(57) ABSTRACT

A method for automatically generating a custom image product by a service provider for a customer having at least one image captured on image bearing medium by the customer and associated related content provided by the service provider. The associated related content relates to an event or to a venue where the at least one image was captured. The method includes the steps of providing a form that includes information that is be used for identifying the associated related content; associating the form with respect to an image bearing medium product having at least one exposed image; forwarding the form and associated image bearing medium to the service provider, the service provider using the information from the form to obtain the related content in digital form and associating the related content in digital form with respect to at least one digital image obtained from the at least one image; and the service provider providing the image product which incorporates the at least one image from the image bearing medium and the related content.

### FIELD OF THE INVENTION

The present invention is directed to image products that have related content associated therewith.

### BACKGROUND OF THE INVENTION

The present invention deals with the association of relevant content with respect to associated personal images that are to be provided on an image product in an unobtrusive and efficient manner. Relevant content may comprise additional information that adds to the pertinence or provides additional value to a consumer captured image. Relevant content may comprise other images, textual information, graphics or multi media content such as movies, audio or animations. The combining of pertinent relevant content with personal image results in a customized image product that is relevant to the owner of the image product. The relevant information may comprise information relating to an event or location at which the images were captured. The image products may comprise any desired product that includes images, for example, but not limited to, photographic albums, posters or books, and any digital representation of images such as interactive CDs, DVDs, digital image display or web based products.

A major problem that exists today with respect to the association of pertinent relevant content/information to custom personal images, is that a great deal of interaction is required by the customer to provide this additional relevant content. Quite often, the customer must engage in numerous steps to identify and associate the pertinent relevant content with respect to the images. For example, a customer must label the images to indicate key information, in either an analog or digital manner. While it has been suggested that a service provider can attempt to evaluate images provided to the service provider and add pertinent content, however, in many cases there is no way for the service provider to provide appropriate information that can be accessed by the service provider.

Thus, there is a need for making it easy to identify pertinent content and to automate the association of the pertinent content with the captured images.

The present invention provides a method and system whereby pertinent relevant content can be associated with captured images that are used to provide image products in an unobtrusive and easy to use manner.

### SUMMARY OF THE INVENTION

In accordance with one aspect of the present invention there is provided a method for automatically generating a custom image product by a service provider for a customer, the custom image product having at least one image captured on image bearing medium by the customer and associated related content provided the service provider, the associated related content relating to an event or to a venue where the at least one image was captured, comprising the steps of:
providing a form that includes information that is be used for identifying the associated related content;
associating the form with respect to an image bearing medium product having at least one exposed image;
forwarding the form and associated image bearing medium to the service provider, the service provider using the information from the form to obtain the related content in digital form and associating the related content in digital form with respect to at least one digital image obtained from the at least one image; and
the service provider providing the image product which incorporates the at least one image from the image bearing medium and the related content.

These and other aspects, objects, features and advantages of the present invention will be more clearly understood and appreciated from a review of the following detailed description of the preferred embodiments and appended claims and by reference to the accompanying drawings.

### BRIEF DESCRIPTION OF THE DRAWINGS

In the detailed description of the preferred embodiments of the invention presented below, reference is made to the accompanying drawings in which:

### BRIEF DESCRIPTION OF THE DRAWINGS

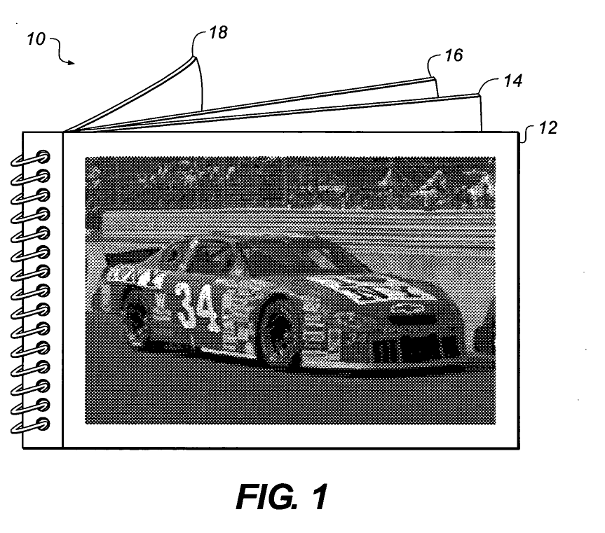

FIG. 1 is a perspective view of a photo album made in accordance with the present invention;

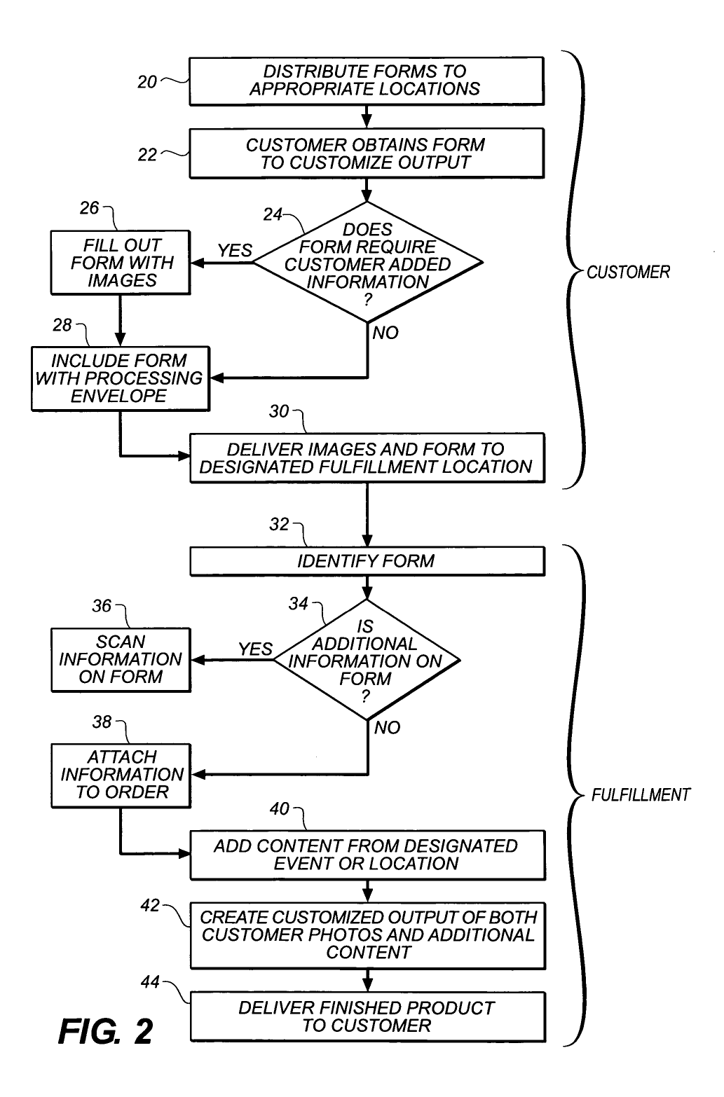

FIG. 2 is a flowchart of the steps of the method according to the present invention;

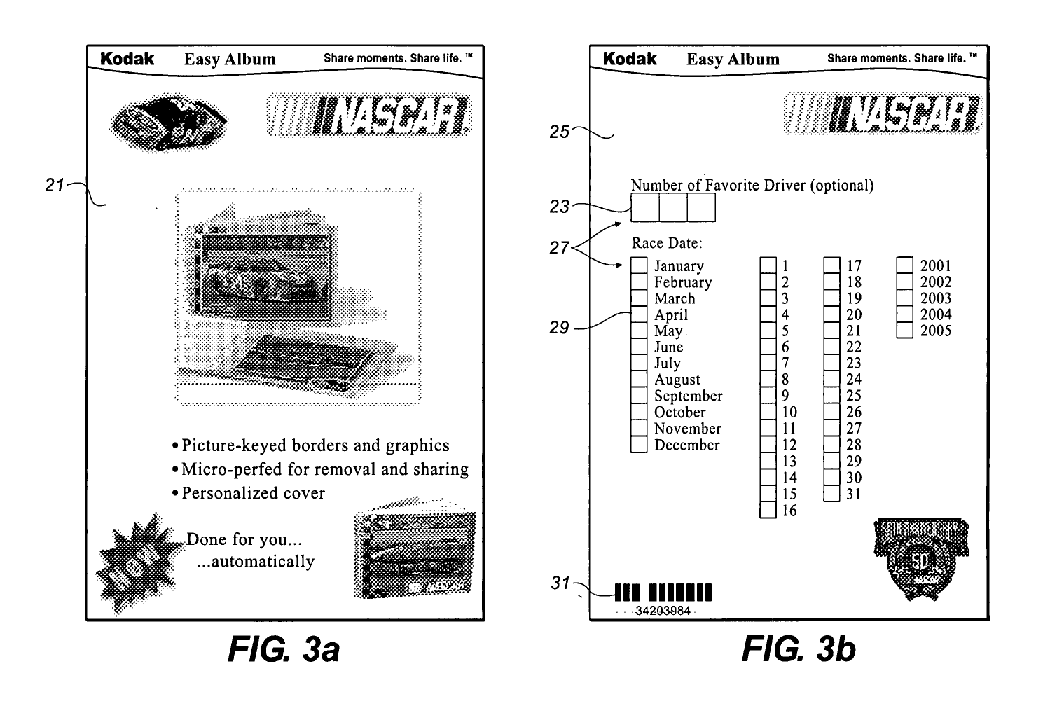

FIG. 3a is a view of the front side of an order form for use in the method according to the present invention for ordering of the image product of FIG. 1;

FIG. 3b is a view of the back side of the order form of FIG. 3a;

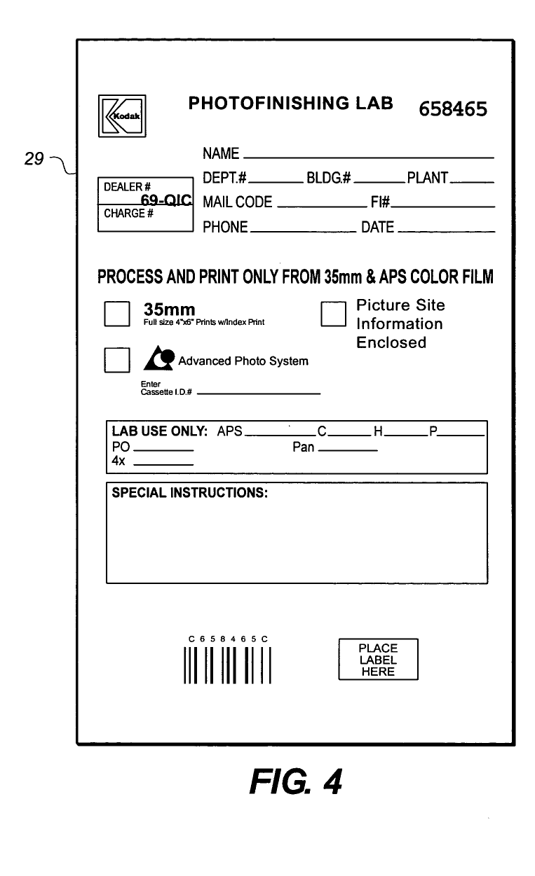

FIG. 4 is a planned view of an order envelope in which captured images and the order form of FIGS. 3a and 3b is placed for ordering of the image product of FIG. 1;

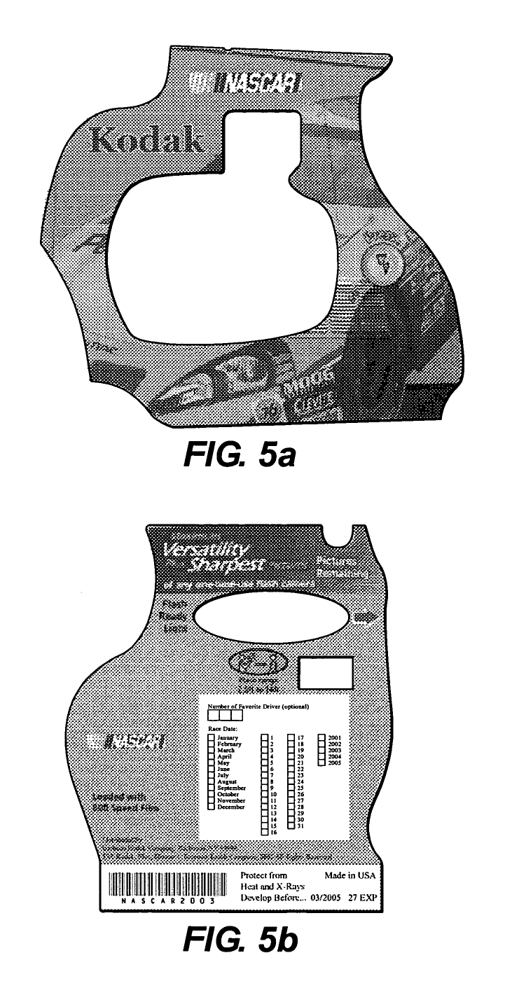

FIGS. 5a and 5b respectively illustrate labels for placement on a single use camera that identify a particular theme in which images captured by the camera are to be associated on an image product;

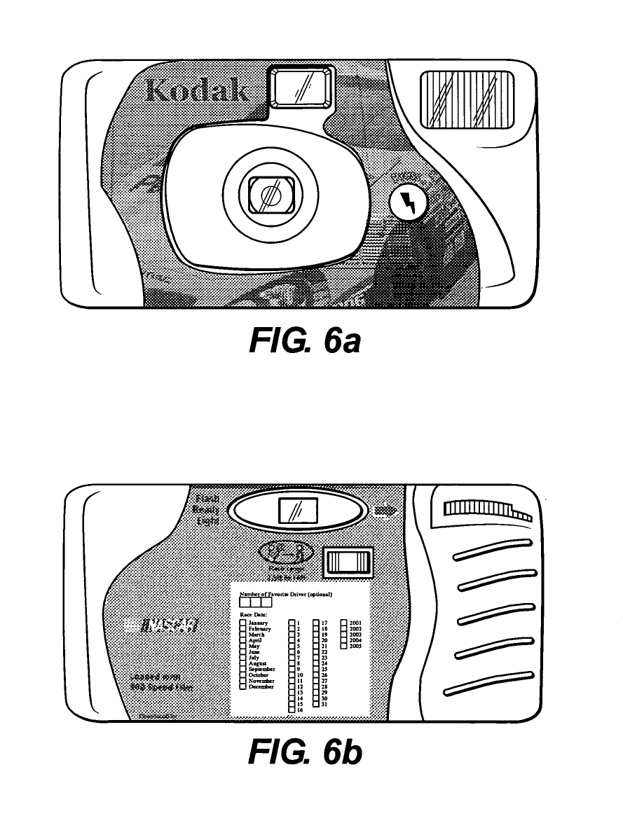

FIGS. 6a and 6b illustrate the front and rear views of a single use camera having placed thereon the labels of FIGS. 5a and 5b respectively;

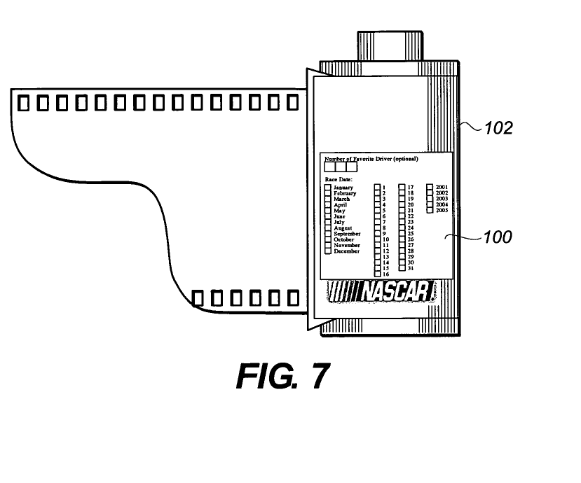

FIG. 7 illustrates the perspective view of an image bearing medium cassette having a sticker thereon that can be used for ordering of an image product that incorporates relevant pertinent content with regard to the images captured on the image bearing medium in the image bearing medium cassette;

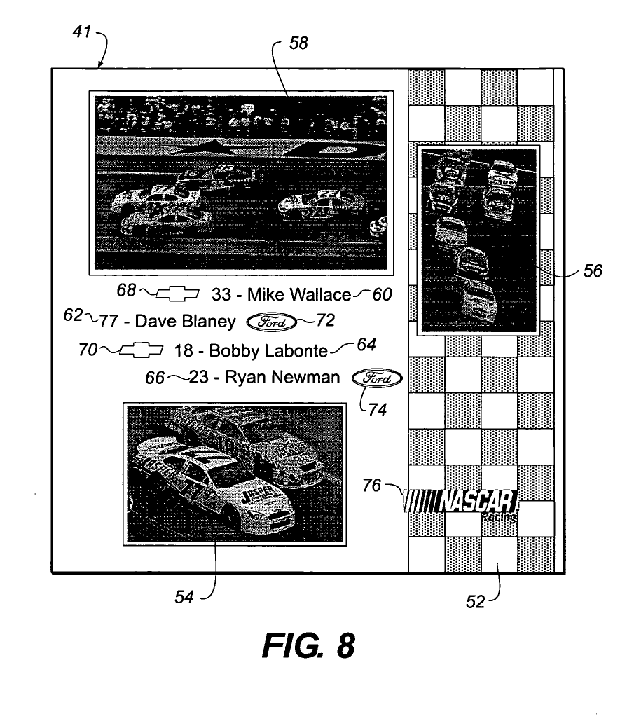

FIG. 8 is a plan view of a typical album page of the photo album of FIG. 1 illustrating professionally captured images and related content that would be used on the album page;

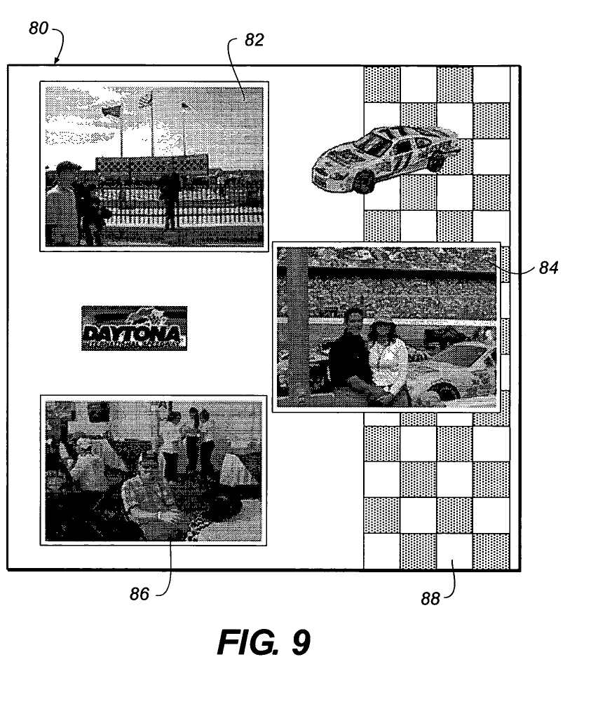

FIG. 9 is a plan view of an album page of the photo album of FIG. 1 that incorporates customer personal images with the theme designated by the order form;

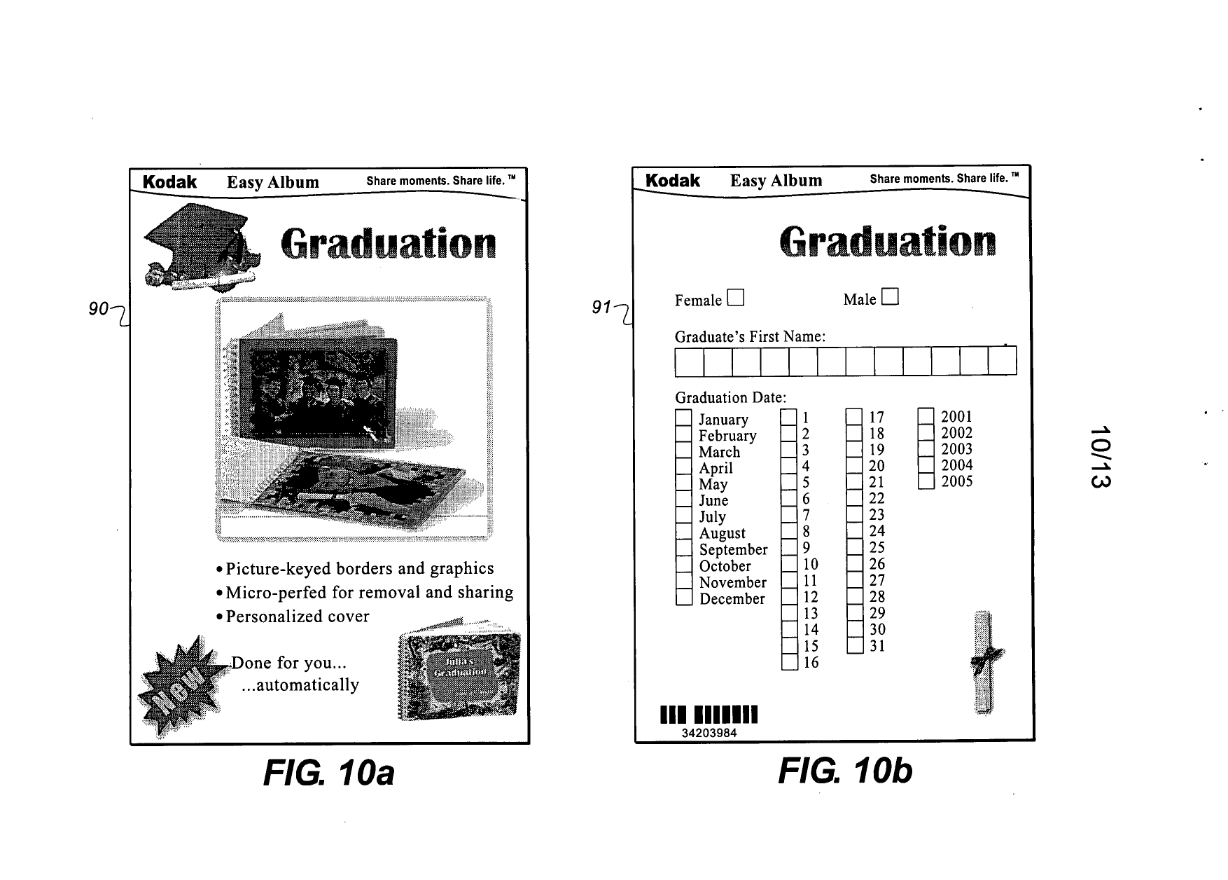

FIGS. 10a and 10b respectively illustrate the front and rear sides of a modified order form for associating pertinent relevant content with respect to images associated with said order form illustrating another theme;

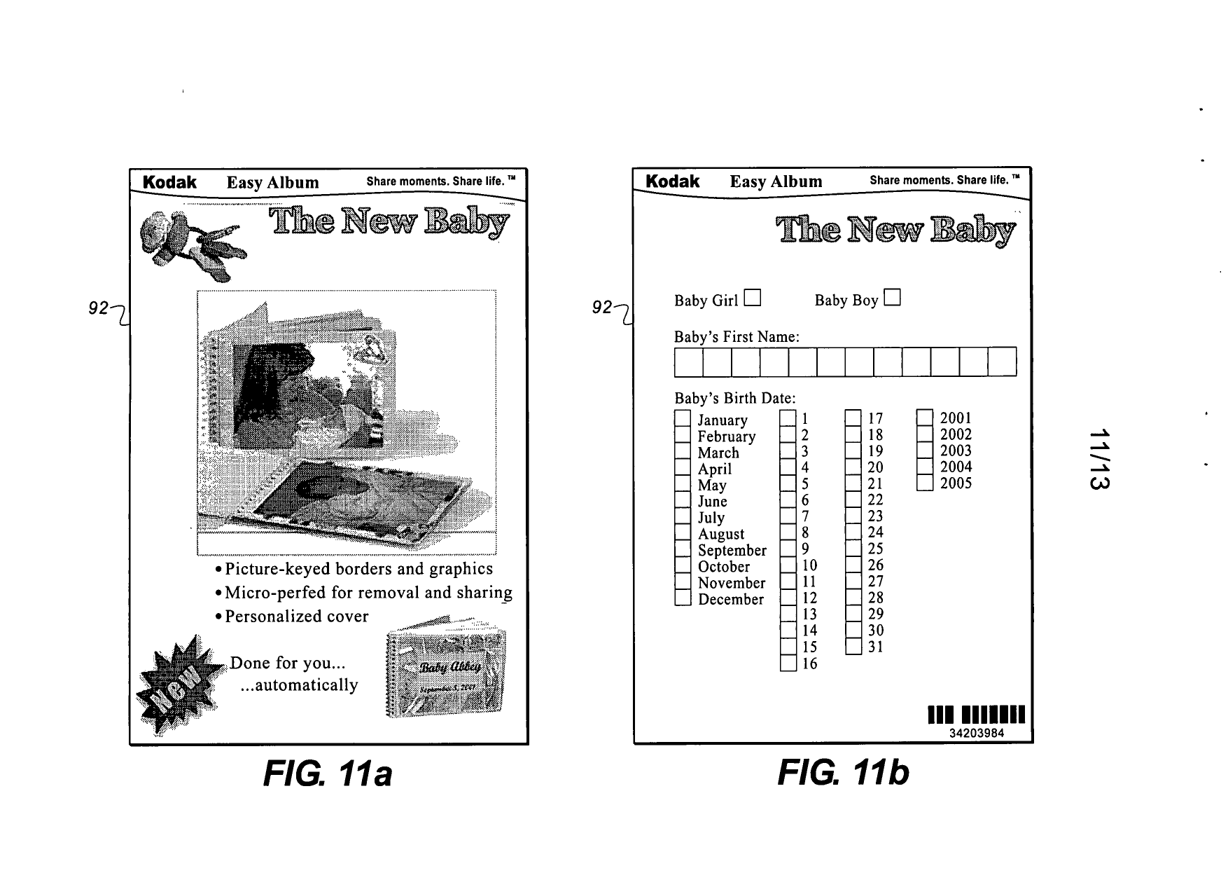

FIGS. 11a and 11b respectively illustrate the front and rear sides of another modified order form for associating pertinent relevant content with respect to images associated with said order form illustrating yet another theme;

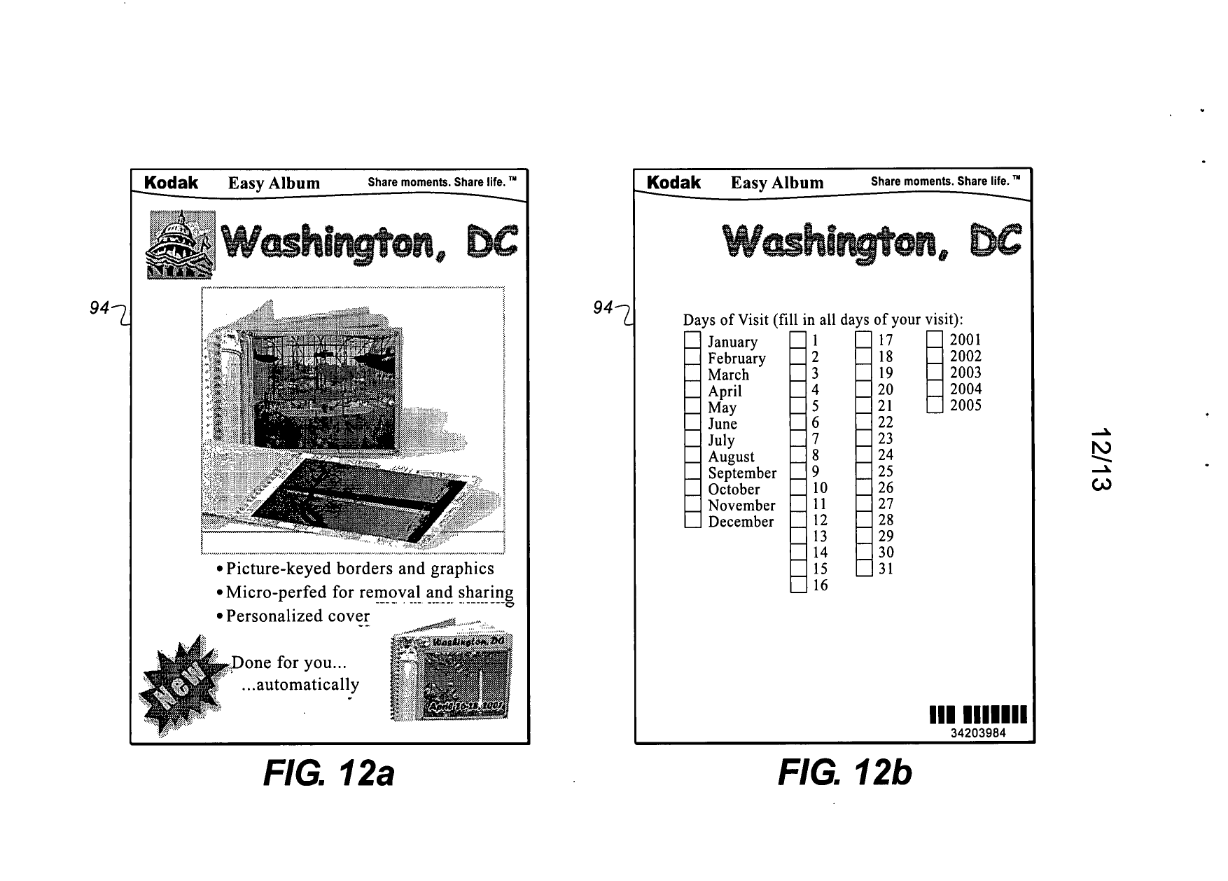

FIGS. 12a and 12b respectively illustrate the front and rear sides of yet another modified order form for associating pertinent relevant content with respect to images associated with said order form illustrating still yet another theme; and

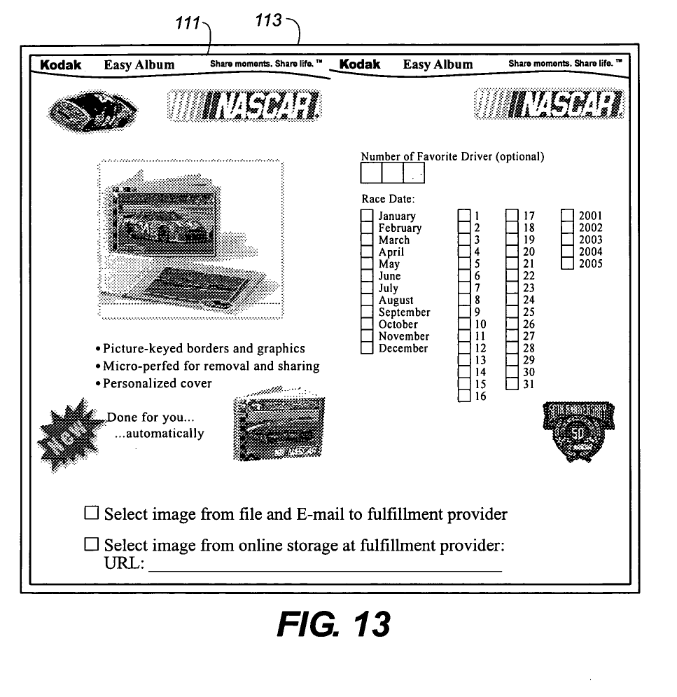

FIG. 13 is a screen shot of a display device illustrating an electronic order form that can be forwarded to a fulfillment provider over a communication network.

### DETAILED DESCRIPTION OF THE INVENTION

Referring to FIG. 1, there is illustrated an image product 10 that incorporates images captured by a customer with pertinent relevant and/or related content. In the particular embodiment illustrated, the image product 10 comprises a photo album having a cover 12 and a plurality of album pages 14, 16 and 18. It is to be understood that the image product may take a variety of other products and forms. For example, but not limited to, posters, books, prints, tee shirts, mugs or any other item that can bear images and any digital representation of images such as computer disks, CDs, interactive CDs, DVDs, digital displays or web based displays or products.

Referring to FIG. 2, there is illustrated a flowchart of the steps for obtaining the image product 10. In the first step 20 of the method, according to the present invention, a custom image product order form 21 (as illustrated by FIGS. 3a and 3b) is distributed so that customers can obtain and use the form 21. The form 21 identifies a particular theme and image product that is to be associated with images provided by a customer. In the embodiment illustrated, form 21 has a theme directed to a race car event sponsored by Nascar and identifies a photo album that is to be provided which would incorporate images provided by the customer employing the designated theme. FIG. 3a shows the front side of form 21 and FIG. 3b illustrates the back side of the form 21. As previously noted, the front side 21 illustrated in FIG. 3a, illustrates the particular image product to be provided and the back side 25 identifies additional information 27 that may be optionally provided by the customer that would be used to identify additional relevant content to also be incorporated into the image product. For example, as illustrated by numeral 23, the number of a racecar or a favorite driver at the event may be provided and the identification of the race date may be provided by filling out the checklist indicated by numeral 29. The number of race cars and/or drivers 23 may also further define the theme in greater specificity.

Step 22 of the method is where the customer acquires form 21 that may be obtained by a variety of different ways. The form 21 may, for example, be obtained by the customer at an event or at a retail establishment. At next step 24 of the method, the customer determines whether or not the form 21 requires additional information. As previously noted, the form 21 in the embodiment illustrated allows for the providing of additional information 27 that can be used to identify additional relevant content to provide to the ordered image product. If the customer desires to provide this additional information, then at step 26 the customer provides the appropriate information on form 21. Otherwise, if there is no ability to provide additional information, or if the customer does not desire to provide such information, the customer proceeds to step 28 where the form 21 is placed in a processing envelope 29 (as illustrated in FIG. 4) along with providing appropriate image bearing medium having the customer images thereon. It is of course understood that the image bearing medium may be provided in any appropriate manner. For example, the image bearing medium may be provided in a typical 35 mm cassette or Advance Photo System cassette, in a single use camera, or even digital images on a memory card. In the embodiment illustrated, the image bearing medium is exposed, undeveloped film that is to be processed by a photo lab (fulfillment provider) as is customarily done. Optionally, the customer may place in envelope 29, already developed image bearing medium such as prints, slides, or negatives for use in ordering the image product using the images therein. At step 30, the envelope 29, along with the exposed and undeveloped image bearing medium, is delivered to a fulfillment provider. Typically, this is accomplished simply by the customer dropping the envelope 29 off at a retail establishment, or alternatively, sending the envelope 29 using delivery services, such as the United States Postal Service, directly to a designated fulfillment location (fulfillment provider).

The order envelope 29 includes all appropriate order information for processing of the image bearing media, as is typically provided in the prior art, for example, but not limited to, customer name, type of image bearing medium enclosed, and product being ordered. In the particular example illustrated, the envelope 29 allows the identification of 35 mm or Advance photo System photographic film. In addition, envelope 29 allows the indication that there is to be provided customer image product as indicated by the picture site information box.

The fulfillment provider, at step 32, after receiving the envelope and contents therein, determines if there is a form 21 present for ordering of a customized image product. If such a form is present, the fulfillment provider obtains the appropriate information for fulfilling of the order. At step 34, the fulfillment provider determines if there is additional information provided on form 21. Additional information is provided on form 21 as illustrated by numeral 27, the form 21 is scanned, by well known techniques (for example OCR, optical character recognition) at step 36 to obtain the appropriate information. This information is then used to identify relevant image content to be associated with the customer images with respect to the ordered image product. The scanning operation can also be used to identify indicium such as a bar code 31 that identifies the particular type of image product that is being ordered. It is of course understood that the form itself, without any bar code, may identity the particular image product being ordered, the theme and relevant content to be applied to the ordered image product. If there is no additional information, at next step 38 the fulfillment provider associates the order form 21 for the customized image product with the image bearing medium provided by the customer. If the image bearing medium has not been developed, such as in the case of photographic film, the image bearing medium is developed so as to obtain the images captured thereon. If the image bearing medium is film, the images developed are converted into a digital format. This is typically done by digitally scanning the developed film for obtaining a digital file of the images. The relevant content previously identified from step 40 is associated with the digital images that have been obtained. The relevant previously stored content is retrieved from stored digital memory. Then at step 42 the fulfillment provider produces the customized image product in accordance with order form 21. Since the order form 21 is directed to a specified type of image product having a particular theme, the output of the customized image product has already been determined. In the preferred embodiment, certain default stored digital images have already been pre-selected for placement in the image product 10. However, if additional information is provided, such as allowed by form 21, the default images or theme can be modified. For example, if the number of the favorite driver is provided at location 23 on form 21, a stored digital image related to the favorite driver may be placed on the cover 12 of the album in place of any default image that may be pre-selected for use in the image product designated by the form 21. Thereafter, the remaining album pages are provided in accordance with predetermined formats designated by the fulfillment provider for that particular image product at step 42. Once the image product 10 has been completed, it is delivered to the customer at step 44.

Referring to FIG. 8, there is an example of an album page 41 that has been made by the fulfillment provider and placed in album 10. This album page 41 utilizes prestored images provided by the fulfillment provider that have been previously designated for being provided with the image product identified by form 21. Preferably, the prestored images are supplied to the photofinisher by the event or site management and/or agent. The pre-stored content may be associated with the particular event the customer has attended and captured personal images during the time the customer attended the event. Here again, in the particular album page 41 illustrated, the identification of the event is known and certain stock images are provided. As illustrated in FIG. 8, album page 41 has a theme background indicated by numeral 52. In addition, the illustrated album page 41 includes three professional images 54, 56, 58 that are associated with the designated event identified by form 21. The additional information relating to car and drivers has also been provided on album page 41 as illustrated by numerals 60, 62, 64 and 66. In addition, various logos 68, 70, 72, 74 and 76 are provided on album page 41. These identifying logos may include sponsors of the event and/or album page. In such case, the cost of the album page and/or image product may be reduced or eliminated due to the sponsorship of the owners of these logos.

FIG. 9, illustrates an album page 80 that incorporate images captured by the customer. In the particular embodiment, the album page 80 has three customer provided images 82, 84 and 86 having a theme background 88. It is to be understood that any particular number and/or style format for album may be provided. An appropriate number of album pages are provided so as to incorporate all of the images provided by the customer on the image bearing medium submitted to the fulfillment provider. The producing of the image product, including the customer image, are dictated by the order form 21 and instructions provided by the customer. Thus, the process for ordering image products 10 can be automated.

Thus, it can be seen that there is provided a photo album that is automatically prepared for a customer that has a particular theme and incorporates customer images. The customer does very little other than supply the images and fill out minimal information on an order form. Alternatively, the customer may only need to select the appropriate order form if that order form has been fashioned to contain indicators only for the particular location or event where the forms are distributed, then the customer need not fill in any information on the form. The order form designates the type of output image product and theme that is to be associated with the image product. The providing of additional optional customer information is done in a manner that is quick and easy for the customer to use, preferably by checking appropriate selection on a form or providing additional information in the designated format. The selection format and additional information format is preferably provided in a format that can be machine read to allow minimal effort on behalf of the fulfillment provider in obtaining the information. Also, as previously described, the order form has machine-readable indicia that identify the image product and theme to be provided to the customer. Thus, there is provided an automated system that allows the ordering of customized image products by a customer that incorporates personal images and images of a particular theme.

It is of course understood that various other themes may be selected. Referring to FIGS. 10a, 10b, 11a, 11b, 12a and 12b, there is illustrated the front side and back side of forms 90, 92 and 94, respectively, for ordering theme albums each directed to different themes. In particular, the order form 90 is directed to a graduation theme and for ordering of a photo album of the type previously discussed with respect to FIG. 1. On the back side 91 of form 90, as illustrated in FIG. 10b, additional information is provided that can be used in producing the custom image product. In the embodiment illustrated, this information includes the gender of the graduate, name of the graduate, and graduation date. Various other information, not illustrated, may be provided, for example, but not limited to, whether the graduation is directed to a grammar school, high school, college, or graduate school, and/or a particular field of study. This would also preferably provide a form of selection boxes that can be read by machine to allow easy and accurate determination of the type of product and/or theme to be produced by the fulfillment provider. Further, by having selection boxes or the specific location for the providing of information, the customer can easily and quickly fill in the information with minimal effort, then all the customer need do is place the order form within the order envelope 29 and the fulfillment provider does all of the other work. The present system also makes is simple and low cost for the fulfillment provider. By having designated image products and associated themes that have been previously prepared, this requires little skill work on behalf of the fulfillment provider and can be easily automated so that the obtaining of the information from the form can be scanned in the fulfillment provider system in an efficient manner.

It is of course, understood that the fulfillment provider may do other acts to improve the quality of the custom image product. For example, but not limited to, the fulfillment provider may analyze the customer generated digital images to assure that they meet desired minimal quality considerations. The fulfillment provider may use algorithms for determining the suitability of images for use in the custom image product. Images that are either blank, low light or are otherwise not suitable for placement in the album can automatically be left out in a manner such as described in U.S. Pat. No. 6,535,636 by Savakis et. al. entitled Method For Automatically Detecting Digital Images That Are Undesirable For Placing In Albums. Thus, the quality of the album can be enhanced by the fulfillment provider using only images of an appropriate minimal quality. Alternatively, those images detected to be unsuitable may be placed in a viewing position such as at the end of a grouping or album so that they may be easily ignored. This section could be referred to as “out takes” to add a humorous aspect to the unsuitable images. Additionally, perforations or other means such as a binder with removable pages, may be provided on all images so that the unsuitable images as determined by the customer can be separated from the suitable images without the benefit of algorithmic analysis.

The form 92 is directed to a “new baby” form as illustrated by FIGS. 11a and 11b and illustrates the type of information that may be provided thereon. Similarly, the form 94 illustrated in FIG. 12a, is directed to a particular location, in particular Washington, D.C. and the dates of the visit is provided on the back side illustrated in FIG. 12b.

In the previous embodiments, the form has been illustrated as being a separate form that is simply placed with the photographic image bearing medium in the order bag/envelope 29. However, it may be possible to provide the order form in different formats. For example, as illustrated in FIGS. 5a and 5b, there are provided labels that may be provided on single use cameras that are typically sold at a theme location or event. As the labels illustrate in FIGS. 5a and 5b, they are designed to be provided on a single use camera as illustrated in FIGS. 6a and 6b, respectively. As can be seen, the information on the label illustrated in FIG. 5a identifies the particular theme for the customer and the label illustrated in FIG. 5b provides the appropriate information to be provided by the customer in machine readable information that can be scanned by the fulfillment provider so that the appropriate image product is produced. The label illustrated in FIG. 5b in the embodiment illustrated basically includes the same information that is provided on the back side of the form 21 illustrated in FIG. 3b.

Alternatively, the information for ordering may be provided directly on a sticker 100 that is applied to an image bearing medium cartridge 102 as illustrated in FIG. 7. The sticker 100 can either be provided ahead of time by the retailer or provided by the customer.

Another alternative is to provide site or event specific processing bags or envelopes. Upon receiving the image bearing medium in the site or event specific envelope, the photofinisher automatically knows that the order is for event or site specific products.

In the previously described examples, photographic image bearing medium bearing customer images are provided to the fulfillment provider for producing of a customized image product. However, it is to be understood that the present invention may also be applied to digital images captured by a customer, for example, digital images provided on a customer computer or other device, in which case, appropriate software may be simply provided that provides the illustration of the order form, e.g. order form 21, on a display device. For example, the form 21, as illustrated in FIGS. 3a and 3b may be displayed on a computer monitor for quick selection and the identification of the images by the normal software such that they will be automatically forwarded to a service provider over a communication network. For example, the order form and images can be forwarded to Ofoto.com or by this information being immediately received without any need for entering onto a web site. In order to ensure that appropriate accounts are debited, a password may be provided on the form so that an appropriate account can be charged without the need of the customer having to sign onto the web site of the fulfillment provider or do any other act. FIG. 13 is an illustrated example of a display form 111 that may be provided on a display device 113 such as a computer monitor for ordering an image product over a communication network. Upon completion of the order form 111, the form would be e-mailed over a communication network, such as the internet, to the designated fulfillment provider wherein fulfillment provider would the read it and provide the appropriate image product. If the images are identified by the order form 111, they are either sent with the form 111 or otherwise identified images that have already been provided to the fulfillment provider and are currently being stored by the fulfillment provider such that the appropriate identification will immediately allow access to the identified images and used to create the appropriate image product. For example, if the images have already been sent to the fulfillment provider or are in the stored bank, there may be an associated URL that can be used by the customer for associating the images. Since the order form is being sent by e-mail, there is no need to log onto a web site of the fulfillment provider, again making the ordering process fast and efficient for the customer. It is to be understood that various other changes and modifications may be made without departing from the scope of the present invention. The present invention being defined by the claims set forth herein.

The invention has been described in detail with particular reference to certain preferred embodiments thereof, but it will be understood that variations and modifications can be effected within the spirit and scope of the invention.

### PARTS LIST

10 image product
12 cover
14 album page
16 album page
18 album page
20 step
21 front side of form
22 step
23 location
24 step
25 back side of form 21
26 step
27 information
28 step
29 location
29 envelope
30 step
31 barcode
32 step
34 step
36 step
38 step
40 step
41 album page
42 step
44 step
50 album page
52 numeral
54 professional images
56 professional images
58 professional images
60 numeral
62 numeral
64 numeral
66 numeral
68 logos
70 logos
72 logos
74 logos
76 logos
80 album page
82 images
84 images
86 images
88 theme background
90 forms
91 back side of form 90
92 forms
94 forms
100 sticker
102 image bearing medium cartridge
111 display form
113 display device

1. A method for automatically generating a custom image product by a service provider for a customer, said custom image product having at least one image captured on image bearing medium by said customer and associated related content provided said service provider, said associated related content relating to an event or to a venue where said at least one image was captured, comprising the steps of:
providing a form that includes information that is be used for identifying said associated related content;
associating said form with respect to a image bearing medium product having at least one exposed image;
forwarding said form and associated image bearing medium to said service provider, said service provider using said information from said form to obtain said related content in digital form and associating said related content in digital form with respect to at least one digital image obtained from said at least one image; and
said service provider providing said image product which incorporates said at least one image from said image bearing medium and said related content.

2. A method according to claim 1 wherein said related content incorporates at least one image.

3. A method according to claim 1 wherein said form further includes a plurality of different selectable information that can be used for identifying said associated related content.

4. A method according to claim 1 wherein said form further includes a machine readable code that allows automatic association with said image bearing medium.

5. A method according to claim 1 wherein said image bearing medium is provided in a one time use camera.

6. A method according to claim 1 wherein said form is provided on a sticker.

7. A method according to claim 1 wherein said form is provided on a sticker on a single use camera.

8. A method according to claim 6 wherein said sticker is associated on a container for holding said image bearing medium.

9. A method according to claim 1 wherein said form includes indicia for orienting said form with a reader so that said information can be machine read from said form.

10. A method according to claim 1 wherein said form is incorporated into a photofinishing order bag.

11. A method according to claim 1 wherein said product incorporates a feature for separating at least one image.

12. A method according to claim 1 wherein said related content is associated with the event or site where said form is available.

13. A method according to claim 1 wherein said image bearing medium comprises photographic film.

14. A method according to claim 1 wherein said image bearing medium comprises a flash memory card of a digital camera.

15. A method according to claim 1 wherein said image bearing medium comprises a print.

16. A method according to claim 1 wherein said image bearing medium comprises a photographic negative.

17. A method according to claim 1 wherein said image bearing medium comprises a photographic transparency.
